(19) United States
(12) Patent Application Publication
(10) Pub. No.: US 2006/0114478 A1
(43) Pub. Date: Jun. 1, 2006

(54) Evaluating effects of tilt angle in ion implantation

(75) Inventors: Peter G. Borden, San Mateo, CA (US); Edward W. Budiarto, Milpitas, CA (US)

Correspondence Address: Patent Counsel, MS/2061;Legal Affairs Dept, Applied Materials, Inc., PO BOX 450A, Santa Clara, CA, 95052, US

(73) Assignee: Applied Materials, Inc.

(21) Appl. No.: 10/998,104

(22) Filed: Nov. 26, 2004

(51) Int. Cl. G01B 11/04

(52) U.S. Cl. 356/636

(57) ABSTRACT

Effect of tilt angle, at which ions are implanted into a semiconductor layer of a wafer, is evaluated by measuring reflectance of a region which has implanted ions in first areas that are interdigitated with a corresponding number of second areas lacking the implanted ions (or having the same specie ions in a background concentration). The second areas are protected during ion implantation either by being covered up or by being in shadows, of bars located over the semiconductor layer. Due to a shadow cast by a bar, only a portion of each opening between two adjacent bars is implanted with ions to form each first area, depending on the tilt angle. Hence, tilt angle is determined e.g. from a bar's shadow's width and the bar's thickness. The bar's shadow's width in turn is determined from the width of an opening and the width of an implanted first area.

### BACKGROUND

Ions are commonly implanted into semiconductor wafers (also called “substrates”) by use of implanters to form a variety of electronic devices. During ion implantation, an ion beam may be angled relative to a substrate's surface, as required by a fabrication process. Methods and structures involving angled implantation of ions are described in, for example, U.S. Pat. No. 5,696,382 issued to Kwang, U.S. Pat. No. 5,344,787 issued to Nagalingam et al., U.S. Pat. No. 5,909,622 issued to Kadosh et al. and U.S. Pat. No. 6,440,812 issued to Violette each of which is incorporated by reference herein in its entirety as background.

The angle (also called “tilt” angle) at which the ions are incident relative to the wafer's surface may be monitored to ensure uniformity (in shape and size) of the electronic devices being fabricated. Measurement of tilt angle is described in US Patent Application 20030224541 filed by Huang et al. and published Dec. 4, 2003 that is incorporated by reference herein in its entirety. According to this patent application, sheet resistivity of an implanted substrate is periodically measured by use of a four point probe, and the tilt angle is adjusted depending on the sheet resistivity measurement (e.g. if greater than 30 ohms/square). Huang's method has the drawback of requiring the probe to contact the wafer.

Tilt angle may also be measured in a non-contact manner, by use of THERMAWAVE's tool as described in one or more of the following articles: (A) “Ion Implantation Angle Variation to Device Performance and the Control in Production” by Z. Y. Zhao, D. Hendrix, L. Y. Wu, and B. K. Cusson, AIP Conference Proceedings Vol 680(1) pp. 666-669. Aug. 26, 2003; (B) “Requirements and Challenges in Ion Implanters for Sub-100 nm CMOS Device Fabrication” by Ukyo Jeong, Zhiyong Zhao, Baonian Guo, Gongchuan Li, and Sandeep Mehta, believed to be published prior to September 2004; and (C) “Precise Beam Incidence Angle Control on the VIISta 810HP” by J. Weeman, J. Olson, B. N. Guo, U. Jeong, G. C. Li, S. Mehta, 14th International Conference on Ion Implantation Technology Proceedings, 22-27 Sep. 2002. Each of the just-identified articles (A)-(C) is hereby incorporated by reference herein in its entirety as background. Note that the methods in these three articles are believed to be describing tilt angle measurement in case of blanket ion implantation of a whole wafer without patterning.

There appears to be no prior art, known to the inventors, that describes how to measure the tilt angle at which ions are implanted into a patterned wafer.

### SUMMARY

Implantation of ions into a semiconductor layer of a wafer that is undergoing fabrication is evaluated, in accordance with the invention, by measuring reflectance of a region which contains a pattern of implanted areas interdigitated with unimplanted areas, followed by taking into account a shadowing effect. Specifically, prior to reflectance measurement, ions are implanted into the semiconductor layer, at a tilt angle through openings between bars of photoresist (or oxide) that protect unimplanted areas during ion implantation. In case of a non-zero tilt angle, each bar casts a shadow into an adjacent opening, so that an area in shadow doesn't receive implanted ions. The just-described in-shadow area and an area that is covered up by a bar together form an unimplanted area that interdigitates with implanted areas.

The inventors have realized that the width of an implanted area changes, depending on the width of a bar's shadow, which in turn is affected by tilt angle. Hence, a reflectance measurement which includes contributions from implanted and unimplanted areas is used in accordance with the invention, with calibration data, to determine an implanted area's width. Note that in several embodiments, the width of the implanted area as determined from reflectance measurement is a value that is averaged across multiple implanted areas, because a probe beam used in these embodiments has a wavelength and a diameter that is greater than (e.g. several times larger than) the implant width. Thereafter, a bar's shadow's width is determined in some embodiments, e.g. as the difference between (a) width of the opening and (b) width of implanted area.

In some embodiments, a tilt angle at which ions are implanted is computed from a bar's shadow's width and the bar's thickness as an inverse tangent of a ratio therebetween. In such embodiments, the tilt angle which is computed as just described is used to decide whether or not an ion implanter is to be adjusted in future fabrication of another wafer, and if necessary the amount of adjustment. Note that in other embodiments, an ion implanter is adjusted directly from a bar's shadow's width, i.e. without computation of tilt angle, e.g. by use of a reference golden sample. Note further that an ion implanter may be adjusted directly from the width of the implanted area as determined from reflectance measurement or even directly from the reflectance measurement itself, depending on the embodiment again exemplified by use of a reference golden sample. Regardless of which parameter is used in adjusting an ion implanter, methods of the type described herein use feed-back control to create implanted areas having dimensions closer to wafer design specifications than in the prior art.

### BRIEF DESCRIPTION OF THE FIGURES

FIGS. 1A and 1B illustrates, in flow charts, acts performed in accordance with the invention, to implant ions at a tilt angle into a semiconductor wafer, and adjustment of tilt angle of the ion implanter.

FIGS. 1C and 1D illustrate, in a cross-sectional side view and a plan view respectively, openings between bars through which ions are implanted into the semiconductor wafer at a tilt angle.

FIGS. 1E and 1F illustrate, in a cross-sectional side view, implanting ions at a maximum value and a minimum value respectively for the tilt angle.

FIG. 2A illustrates, in a flow chart, acts performed in certain embodiments of the invention illustrated in FIG. 1A, including calibration of reflectance measurement as a function of width/pitch ratio and calculation of tilt angle as inverse tangent of a ratio of shadow width to bar thickness.

FIG. 2B illustrates, in a cross-sectional view, reflectance measurement by use of a probe beam of wavelength λ that is larger (e.g. several times larger) than pitch Pmask of the implanted areas in some embodiments of the invention.

FIG. 2C illustrates, in a graph, calibration data for reflectance measurement (shown along the y-axis) as a function of the ratio Wimplant/Pmask (shown along the x-axis).

FIG. 3A illustrates, in a cross-sectional side view, a wafer of some embodiments that contains not only interdigitated implanted and unimplanted region 296, but additionally a region 298 that is completely unimplanted, and another region 297 that is completely implanted.

FIG. 3B illustrates, in a plan view, pump and probe beams that are concentric with one another.

FIG. 4 illustrates, in a flow chart, acts performed in certain exemplary embodiments in accordance with the invention.

FIGS. 5 and 6 illustrate, in graphs, the relationship of signal to dose and to tilt angle respectively.

FIG. 7 illustrates, in a cross-sectional view, ion implantation in two directions by rotation of a wafer during ion implantation, to form source and drain extensions that extend under a gate in certain embodiments in accordance with the invention that measure and adjust tilt angle.

FIGS. 8A and 8B illustrate, in block diagrams, various components used in one implementation of the tilt angle identifier of FIG. 1A.

### DETAILED DESCRIPTION

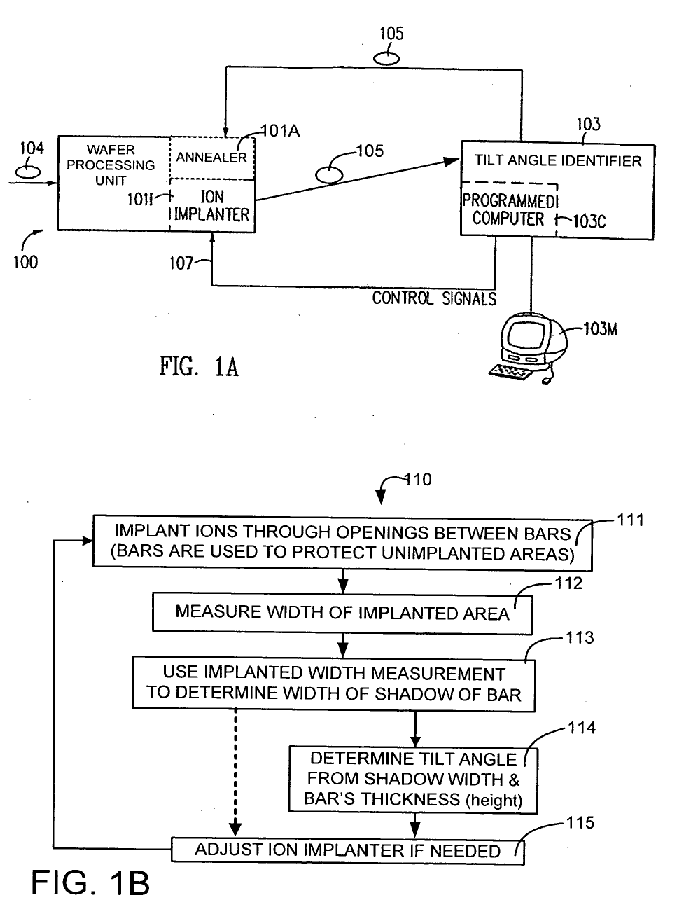

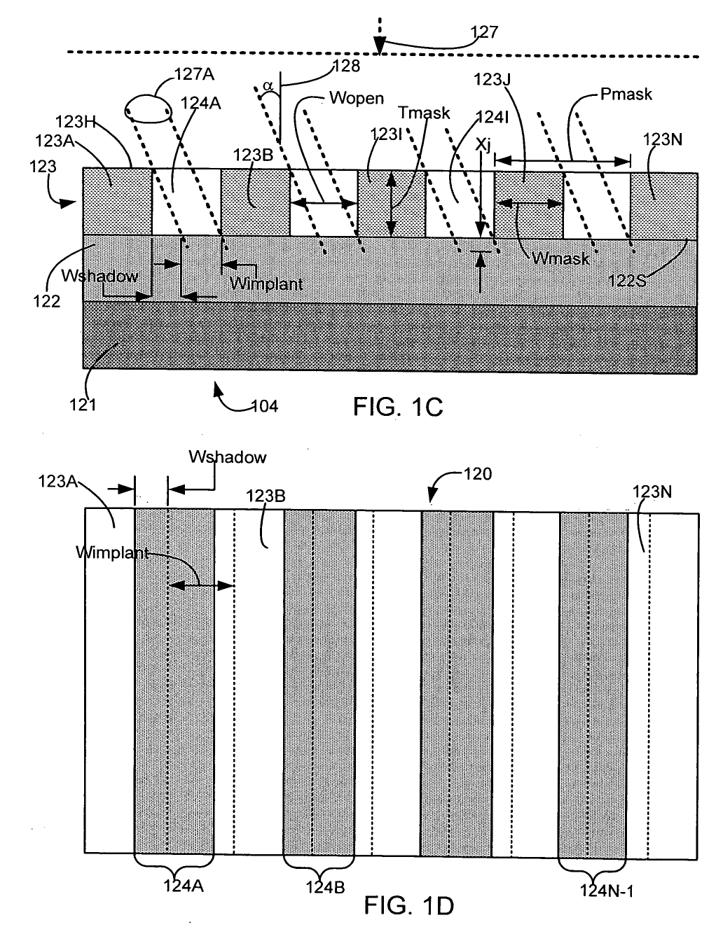

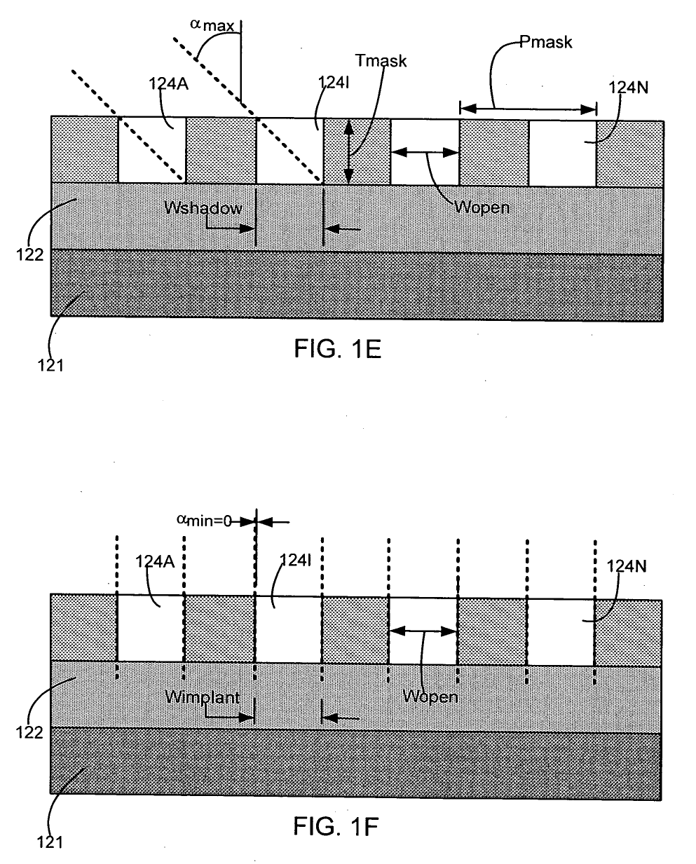

A wafer fabrication system 100 (FIG. 1A) in accordance with the invention is used to create integrated circuit (abbreviated as “IC”) dies by ion implanting a wafer to form a “patterned wafer”, measuring a geometric property of the patterned wafer, and adjusting ion implanting in real time if necessary. The measurement of a geometric property is performed on an implanted wafer prior to annealing, thereby to determine a tilt angle at which ions are implanted.

System 100 includes a wafer processing unit 101 that performs an act 111 (FIG. 1B) e.g. by operating an ion implanter 101I to create, in a to-be-implanted wafer 104 (FIG. 1A), one or more regions that have dopant atoms (e.g. boron atoms in silicon). Thereafter, an implanted wafer 105 having one or more patterns of doped regions is transferred to a measurement device 103 (called “tilt angle identifier”) and positioned therein. Tilt angle identifier 103 may be located physically adjacent to system 100 in some embodiments. In other embodiments, tilt angle identifier 103 may be integrated into ion implanter 101I,

Some embodiments of the tilt angle identifier 103 include a programmed computer 103C, such as an IBM compatible Personal Computer (PC). Note that a video monitor 103M may be coupled to the PC, to allow an operator to manually review tilt angle value(s) identified by tilt angle identifier 103.

After positioning of wafer (if necessary), tilt angle identifier 103 measures tilt angle of implants in wafer 105. If the tilt angle is within acceptable limits, wafer 105 is transferred to a rapid thermal annealer (also called “annealer”) 101A that performs annealing, e.g. by heating wafer 105 (FIG. 1A) to a predetermined temperature (also called “annealing temperature”), to activate the dopant atoms and remove damage that is normally caused by ion implanter 101I to the lattice structure of the semiconductor material in the implanted regions (also called “doped” regions) of wafer 105.

In accordance with the invention, the tilt angle is measured over a test structure that has a number of bars of a masking layer, and ions are implanted through openings between the bars (as per act 111 in FIG. 1B). For example, FIGS. 1C and 1D illustrate a number of elongated bars 123A-123N (of a masking layer 123) that are located at the top of wafer 105. Note that each bar 123I is separated from an adjacent bar 123J by an opening 124I of a known dimension.

Bars 123A-123N are formed by photolithography, e.g. by etching a masking layer 123 that may be formed of photoresist or of a hard material such as silicon dioxide or silicon nitride. The just-described hard material is used in embodiments in which wafers are prepared and set aside for later use without degradation of the mask. When a hard material is used, an additional layer of photoresist is used in some embodiments, to etch openings through the hard material.

In many embodiments, mask layer 123 consists of a set of bars of width Wmask that are arranged periodically in space at a pitch Pmask, and are spaced from one another by openings of width Wopen. For example, the bars may have width Wmask of 0.2 μm and thickness Tmask of 0.2 μm, with openings having a width Wopen of 0.2 μm. In the just-described example, the pitch Pmask is 0.4 μm. Depending on the embodiment, Wmask may be as small as 30 nanometers (i.e. 0.03 μm) or as large as 1 μm. Moreover, Pmask of some embodiments is 2*Wmask. In the just-described example, if the relationship Pmask=2*Wmask is observed, Pmask can be as small as 60 nanometers and as large as 2 μm. Finally, thickness Tmask can be as small as 0.05 μm or as large as 2 μm.

Wafer 104, prior to use of mask 123 may or may not contain a background concentration of ions (e.g. 10¹⁵/cm³ Boron ions) that are same as the ions to be implanted (i.e. same specie ions), depending on the embodiment. In embodiments that do contain such a background concentration, the same specie ions may have been implanted by a prior implantation step or may have resulted from growing of wafer 104 (e.g. growing of the silicon substrate therein). In such embodiments, subsequent ion implantation at the tilt angle results in greater concentration of these same specie ions in the implanted regions (as discussed below) than the background concentration.

When ions to be implanted are directed at wafer 104 at an angle α relative to normal 128 (line 128 is perpendicular to wafer surface 122S), only ions in a small portion 127A of ion beam 127 reach semiconductor layer 122, in an area of width Wimplant, through an opening 124A. Ion beam 127 has a diameter that is orders of magnitude larger than width Wmask of the bars of the masking layer (e.g. beam 127 may have a diameter on the order of one or more centimeters). Note that an area of width Wshadow in opening 124A is protected from ion beam 127 due to a shadow cast by bar 123A. Specifically, the ions that would have reached the Wshadow area are blocked by an upper exposed surface 123H of masking layer bar 123A, due to non-zero tilt angle α.

Note further that in wafers where tilt angle α is at a maximum value, the width Wimplant is zero (as shown in FIG. 1E) i.e. no ions are implanted. As an example, when the opening width Wopen is same as the thickness Tmask, then the maximum tilt angle is 45°. And in wafers where tilt angle α is at a minimum value (of zero) the width Wimplant is maximum (as shown in FIG. 1F), i.e. Wimplant=Wopen. Therefore, the effect of tilt angle α on ion implantation is evaluated in accordance with the invention, by measuring the width of implanted area Wimplant as per act 112 (FIG. 1A). Note that in many embodiments, act 112 involves performing a reflectance measurement across a region that contains several implanted areas interdigitated with unimplanted areas. In alternative embodiments, instead of reflectance measurement, any other width measurement technique may be used.

Also in accordance with the invention, after the implanted area's width is measured, the shadow width Wshadow is determined, as per act 113 in FIG. 1B. Thereafter, in some embodiments, the tilt angle is determined from the shadow width Wmask and bar's thickness Tmask as per act 114 and the tilt angle in turn is used to adjust the ion implanter as per act 115 in FIG. 1B. Alternative embodiments skip act 114, and go directly from act 113 to act 115, e.g. by using a reference sample.

Evaluation of tilt angle effects by measurement of reflectance of implanted areas in a wafer as described above in reference to FIGS. 1A-1F is commercially valuable, because it finds problems at an earlier stage in wafer fabrication, before anneal and before it is possible to test such structures electrically. Early-stage identification of problems, e.g. by reflectance measurement after ion implantation but before anneal, is used to improve yield in many embodiments of the invention.

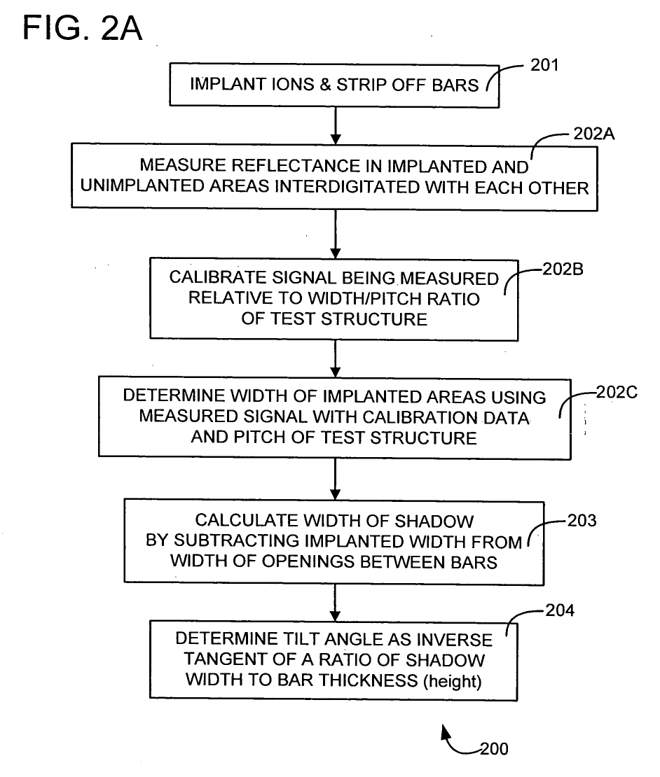

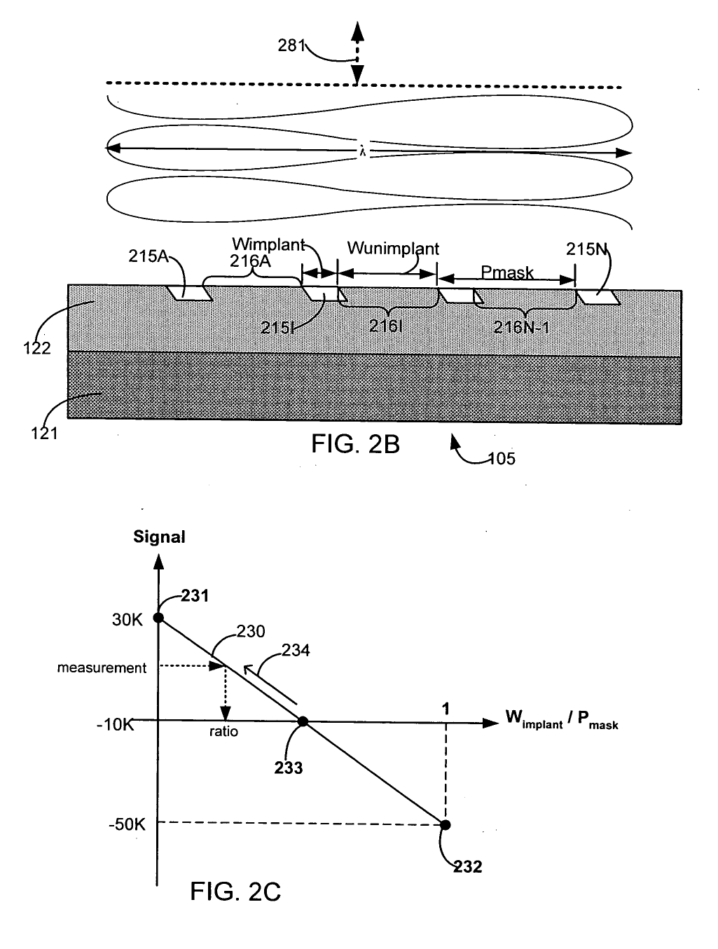

Certain embodiments of the invention perform a method 200 illustrated in FIG. 2A, as described next. Specifically, in act 201, ions are implanted and thereafter the bars 123A-123N are stripped off. Wafer 105 resulting from act 201 is illustrated in FIG. 2B. Next, as per act 202A in FIG. 2A, reflectance is measured across a region in wafer 105 that contains implanted areas 215A-215N of width Wimplant interdigitated with unimplanted areas 216A-216N−1 of width Wunimplant. Note that the unimplanted areas 216A-216N−1 of FIG. 2B are protected from the ions being implanted not only by being covered up by bars 123A-123N (FIG. 1C) of width Wmask but also by being located within the shadow of width Wshadow, so that Wunimplant=Wmask+Wshadow.

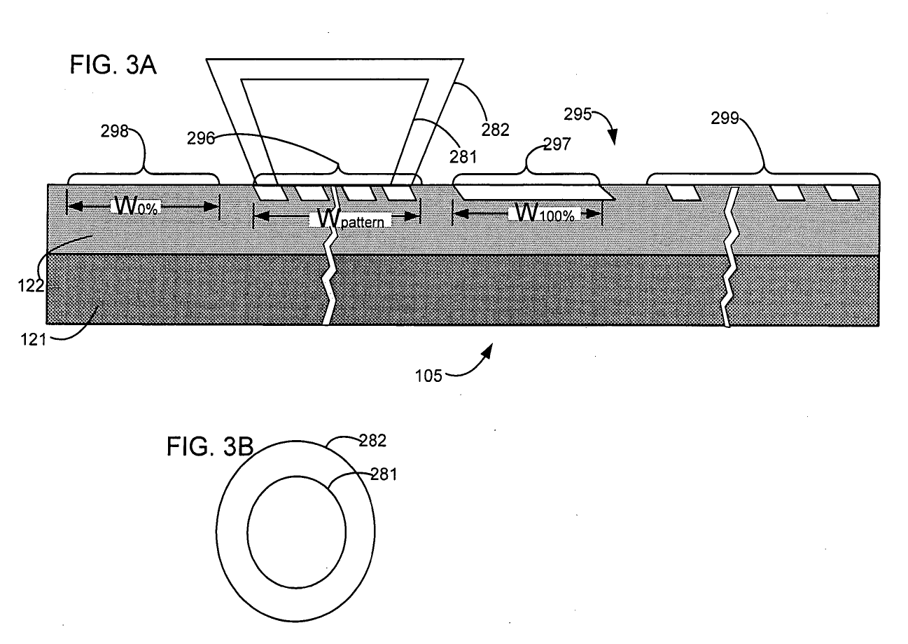

In some embodiments, act 202A is performed by use of a pump beam 282 (FIG. 3A) that is modulated with a predetermined waveform, e.g. a sinusoidal waveform at a predetermined frequency, and by use of a probe beam 281 whose reflectance is measured. In several embodiments, the predetermined modulation frequency of a pump beam 282 used in act 202A is deliberately kept sufficiently small to avoid creation of a wave of charge carriers in space, and probe beam 281's intensity that oscillates at the predetermined frequency is measured. In such embodiments, a reflectance measurement is performed by a method called “Carrier Illumination” which is described in detail in one or more of U.S. patent application Ser. Nos. 09/544,280, 09/274,821, and 09/799,481 each of which is incorporated by reference herein in its entirety.

In one embodiment, the power of the pump beam 282 is modulated at a predetermined frequency, although in other embodiments the modulation may encompass multiple frequencies or patterns in time, such as a chirp or a phase code. Hence, the instantaneous number of charge carriers that are generated in semiconductor layer 122 (FIG. 3A) by the pump beam 282 changes at the frequency of modulation. The modulation frequency is selected in some embodiments to be sufficiently low to ensure that at least a majority of charge carriers that are created in the illuminated spot are transferred out of the spot not by a plasma wave but by diffusion.

As noted briefly above, the power of a portion of probe beam 281 that reflects from wafer 105 is measured as per act 202A at the frequency of modulation of pump beam 282. Reflectance of charge carriers in the illuminated spot (by use of concentric beams as shown in FIG. 3B) may be measured in act 202A in any manner, e.g. by use of a photosensitive element to measure energy of probe beam 281 that is reflected from the region under evaluation. Depending on the embodiment, a photosensitive element (or an array of such elements) of the type used in act 202A may be tuneable to a wavelength (or a wavelength range) of interest (e.g. 0.4-1.5 micrometer). Instead of tuning, a filter or other device may be used to limit radiation incident on the photosensitive element.

In one example of a Carrier Illumination method, probe beam 281 (FIG. 3A) is generated by a laser, such as a 980 nm fiber coupled laser diode, model 26-8052-150 having a maximum output power of 150 milliwatts, available from JDS Uniphase, San Jose, Calif. In some embodiments, the probe beam is selected to be any laser beam having a wavelength between 0.4 μm to 1.5 μm.

In some Carrier Illumination methods, a pump beam is used to generate charge carriers whose reflectance is being measured by the probe beam. The pump beam of such embodiments is created by an above bandgap laser, such as a 830 nm laser diode model SDL-5432-H1, available from JDS Uniphase, San Jose, Calif. The pump and probe beam wavelengths are selected in several embodiments to ensure that the respective beams contain photons having energy above and below (or same as) silicon's bandgap energy. In one example, for a silicon wafer, 830 nm and 980 nm wavelength beams are used as pump beam and probe beam respectively.

Certain alternative embodiments that are expressly contemplated by the inventors perform a reflectance measurement of act 202A by use of a wave (of heat and/or electron plasma) to measure damage caused by ion implantation. In some of these alternative embodiments, a measurement of the implantation damage is performed as described in a brochure entitled “TP-500: The next generation ion implant monitor” dated April, 1996 published by Therma-Wave, Inc., 1250 Reliance Way, Fremont, Calif. 94539 which is incorporated by reference herein in its entirety. The device TP-500 requires “no post-implant processing” (column 1, lines 6-7, page 2) and “measures lattice damage” (column 2, line 32, page 2) in the alternative embodiments.

The TP-500 that is used in some alternative embodiments may include “[t]wo low-power lasers [that] provide a modulated reflectance signal that measures the subsurface damage to the silicon lattice created by implantation. As the dose increases, so do the damage and the strength of the TW signal. This non-contact technique has no harmful effect on production wafers” (columns 1 and 2 on page 2). Hence the TP-500 is used to provide a measure of the width of implanted areas in wafer 105.

Some alternative embodiments use one or more methods described in U.S. Pat. No. 4,579,463 granted to Rosencwaig et al. that is incorporated herein by reference in its entirety. In these embodiments, act 202A is performed by measuring a change in reflectance caused by a periodic change in temperature of a wafer's surface (see column 1, lines 7-16). Specifically, act 202A uses “thermal waves [that] are created by generating a periodic localized heating at a spot on the surface of a sample” (column 3, lines 54-56) with “a radiation probe beam . . . directed on a portion of the periodically heated area on the sample surface,” and the method “measur[es] the intensity variations of the reflected radiation probe beam resulting from the periodic heating” (column 3, lines 52-66).

Several alternative embodiments perform act 202A as described in U.S. Pat. No. 4,854,710 granted to Opsal et al. that is also incorporated herein by reference in its entirety. In such embodiments, act 202A performs a method wherein “the density variations of a diffusing electron-hole plasma are monitored to yield information about features in a semiconductor” (as stated by Opsal et al. in column 1, lines 61-63). Specifically, Opsal et al. state that “changes in the index of refraction, due to the variations in plasma density, can be detected by reflecting a probe beam off the surface of the sample within the area which has been excited” (column 2, lines 23-31) as described in “Picosecond Ellipsometry of Transient Electron-Hole Plasmas in Germanium,” by D. H. Auston et al., Physical Review Letters, Vol. 32, No. 20, May 20, 1974.

Opsal et al. further state (in column 5, lines 25-31 of U.S. Pat. No. 4,854,710): “The radiation probe will undergo changes in both intensity and phase. In the preferred embodiment, the changes in intensity, caused by changes in reflectivity of the sample, are monitored using a photodetector. It is possible to detect changes in phase through interferometric techniques or by monitoring the periodic angular deflections of the probe beam.”

Regardless of which of the above-described methods (or any other known method) is used to measure reflectance in act 202A (FIG. 2A), in some embodiments a probe beam 281 is deliberately selected to have a wavelength λ that is larger than the pitch Pmask, as illustrated in FIG. 2B. Therefore, width Wimplant being measured via reflectance is a sub-wavelength measurement. In one such example, wavelength λ of probe beam is 1480 nm which is more than three times the pitch which in this example is 0.4 μm. At such sub-wavelength dimensions, the reflectance measurement does not identify the width of an individual implanted area 215I (FIG. 2B), and instead the reflectance measurement indicates an average measure of the implanted width in the interdigitated region 296 (FIG. 3A) of width Wpattern.

Also, regardless of which method is used to measure reflectance, the measured signal is calibrated in many embodiments as per act 202B in FIG. 2A, against a ratio of width to pitch of the test structure (which as noted above includes interdigitated implanted and unimplanted areas). In many embodiments, the ratio is of implanted area width Wimplant to mask pitch Pmask. However, in other embodiments the ratio is of unimplanted area width to mask pitch.

Calibration that is performed in act 202B yields data of the type illustrated in FIG. 2C. As shown by point 231 in FIG. 2C, when a region 298 (FIG. 3A) is fully unimplanted e.g. because it is completely protected during ion implantation, the signal has its maximum value, and the implanted width Wimplant is zero. On the other hand, as shown by point 232 in FIG. 2C, when a region 297 (FIG. 2D) is fully implanted (e.g. because it is not protected during ion implantation), the signal has its mimimum value. In some embodiments, all calibration data fits a straight line 230 (FIG. 2C) that connects these two points 231 and 232 (of maximum value and minimum value). Note that FIG. 2C is a linear model, whereas more realistic data is illustrated in FIG. 5.

Note that regions 297 and 298 are made of dimensions sufficiently large to at least contain a spot made by the probe beam (e.g. W_{0%} and W_{100%} shown in FIG. 3A are made no smaller than probe beam diameter), to ensure that an appropriate reflectance measurement is obtained for calibration. In one example, probe beam wavelength is 0.98 μm, probe beam diameter is 3 μm, and widths W_{0%} and W_{100%} are both 12 μm. Note also that regions 296-298 are just small portions of a die 295 (FIG. 3A) that includes one or more other regions separate and distinct from regions 296-298, e.g. region 299 in FIG. 3A contains portions of electronic devices (such as metal-oxide-semiconductor (MOS) transistors) that are normally fabricated in a production wafer.

Depending on the embodiment, regions 296-298 may be present within (or in a scribe line adjacent to) every die or only present in certain periodically spaced apart dies in a wafer. Although in most embodiments regions 296-298 are distinct from region 299, in some embodiments regions 296-298 are formed within region 299, e.g. region 296 may be formed by portions of an SRAM, whereas regions 297 and 298 may be formed by portions of a power transistor or a large capacitor.

Note that as line 230 (FIG. 2C) is a straight line, any two points are adequate to determine this line. Hence, alternative embodiments use other measurements to determine line 230. For example, a wafer may be prepared specifically for calibration (i.e. not a production wafer) by forming bars in the masking layer at a ratio Wmask/Pmask of value 0.5, and implanting it with ions at 0° tilt angle (e.g. see FIG. 1F). Such a calibration wafer is used in some embodiments to determine a point 233 on the x-axis. Note that as tilt angle is increased from 0° to its maximum value, the signal value increases and ratio value decreases as their relationship moves along line 230 towards the top left direction, as shown by arrow 234. Note that at points 231 and 232, the tilt angle is irrelevant, because the signal value remains the same regardless of the tilt angle.

The above-described point 233 at 0° tilt angle is used with maximum value point 231 (FIG. 2C) obtained by measurements in a region 298 (FIG. 3A) with no implants, to determine line 230 in some embodiments. As will be apparent to the skilled artisan, point 233 may alternatively be used with minimum value point 232 (FIG. 2C) obtained by reflectance measurement in a region 297 (FIG. 3A) with 100% implants to determine line 230, depending on the embodiment.

Although a calibration wafer has been described as being used to identify only one point on line 230, in still other embodiments, the calibration wafer is used to identify two points and hence line 230. For example, such other embodiments may measure reflectance in a completely implanted region of the calibration wafer and/or in a completely unimplanted region of the calibration wafer, in addition to or instead of the above-described measurement in the region with 0.5 ratio and 0° tilt angle. Still other embodiments may prepare a number of sets of bars in the calibration wafer, with each set of bars having a different value for the ratio Wmask/Pmask.

Embodiments wherein calibration measurements are performed in a production wafer (e.g. by use of regions 297 and 298 in addition to region 296) are advantageous because the measurements are performed locally which improves accuracy by eliminating global non-uniformity in the measurements. Moreover, such embodiments do not use a calibration wafer that is otherwise required solely to calibrate the tilt angle measurement process, thus reducing costs.

After calibration data of the type shown in FIG. 2C is obtained, the calibration data is used to convert a signal value from reflectance measurement in the interdigitated area into a ratio value as illustrated in FIG. 2C. Note that the conversion may be performed by table lookup, or graph lookup, or by computation if coefficients of an equation y=mx+c for line 230 are identified by curve fitting of calibration data.

Specifically, in the example illustrated in FIG. 2C, a signal value of 10K microvolts is converted into a ratio of value 0.25. Hence, in this manner, calibration data of the type illustrated in FIG. 2C is used in act 202C (FIG. 2A) of several embodiments, to convert reflectance measurement into a value of the ratio. The ratio's value, in turn, is used in such embodiments to obtain width of an implanted region, if pitch Pmask is known.

In some embodiments, the nominal value of the pitch used in fabrication of the bars in region 296 is used with the ratio, to compute the implant width. However, other embodiments use the actual pitch Pmask in region 296, which is measured by any technique known in the art, e.g. by use of a scanning electron microscope (SEM). A SEM is a standard tool in virtually all semiconductor fabs nowadays, and SEM measurement of mask critical dimension (CD) is a well-known method as described in, for example, T. Yoshimura, et. al., “Nanometer-level metrology with a low-voltage CD-SEM”, SPIE Proceedings vol. 3332, p. 61-70, 1998 which is incorporated by reference herein in its entirety.

Next, in the embodiments illustrated in FIG. 2A, width of the area in shadow i.e. Wshadow is computed as per act 203, e.g. from width obtained in act 202C and the width of an opening between bars, i.e. Wopen. Note that Wopen may be measured, e.g. by use of a scanning electron microscope. Thereafter, as per act 204, tilt angle cc is computed as the inverse tangent of the ratio Wshadow/Tmask, wherein Tmask is the thickness of the bars. Depending on the tilt angle to be used in ion implantation and the width Wimplant of the implanted area, thickness Tmask may be deliberately selected to be as low as 500 Angstroms or as high as 2 μm. In some embodiments, the nominal value of the thickness Tmask used in fabrication of the bars in region 296 is used with implant width Wimplant obtained from measurement as described above, to compute the ratio (and hence tilt angle). However, other embodiments use the actual thickness Tmask which is measured in the large fully-masked region 298 (FIG. 3A) by use of an ellipsometer, or an atomic force microscope (AFM), or in any manner known in the art. For example, see W. R. Runyan and T. J. Shaffner, Semiconductor Measurements & Instrumentation, 2nd ed., McGraw Hill, New York, 1997, Chapter 7 and Chapter 14, and these two chapters are incorporated by reference herein in their entirety.

Incorporated by reference herein in their entirety are U.S. patent application Ser. Nos. 10/253,119 and 10/253,121 both entitled “Measurement of Lateral Diffusion of Diffused Layers”, and both filed on Sep. 23, 2002. These two patent applications describe wafers in which test structures include elongated doped areas located at regularly spaced intervals relative to one another of the type described herein. In addition, as noted above, a planar region that is fully doped, and another planar region that is fully undoped are both included in wafers of some embodiments, for use in calibration of a measurement that covers the interdigitated doped and undoped areas.

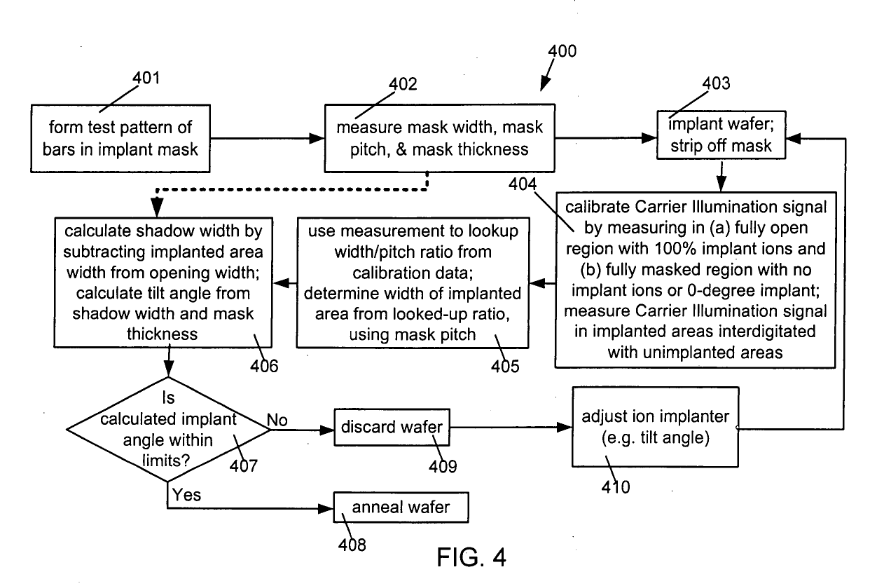

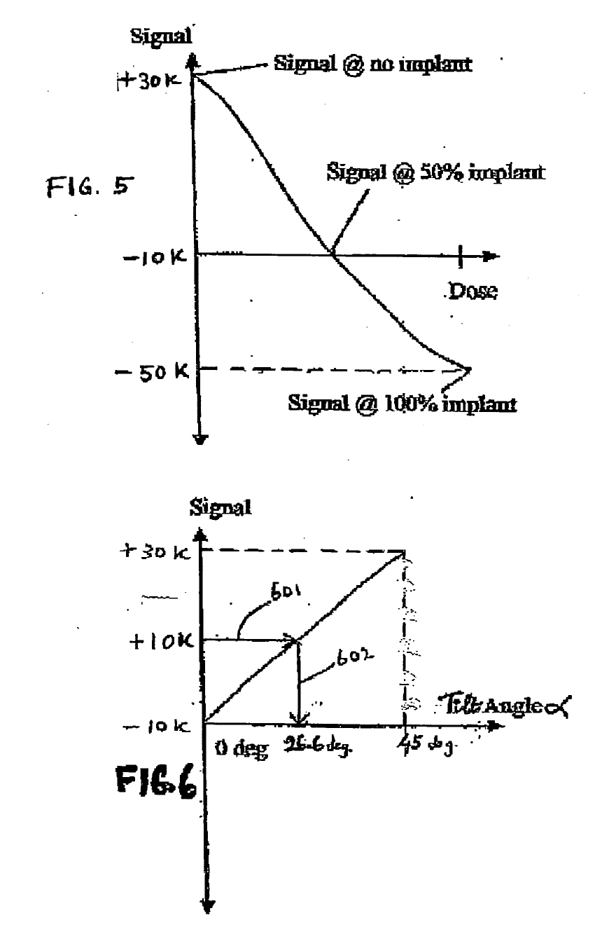

Some embodiments of the invention perform a method 400 (FIG. 4) wherein after formation of test structure(s) of bars in an implant mask (as per act 401 in FIG. 4), one or more dimensions of the implant mask are measured over each of a number of dies as per act 402. Specifically, in act 402, the mask width Wmask and mask pitch Pmask are measured by SEM (as discussed above), and furthermore mask thickness Tmask is measured by an ellipsometer or an AFM (also as discussed above). Next, as per act 403, ions are implanted into wafer 105 (FIG. 1A), followed by removal of the masking layer 123 (FIG. 1C).

Next, as per act 404, calibration data is obtained from the production wafer, e.g. by measuring reflectance (as per the above-described carrier illumination method) in a fully open region with 100% implant ions and in a fully masked region with no implants (alternatively as noted above, a specially-prepared wafer having implants at 0 degrees may be used for calibration). Also in act 404 the carrier illumination method is used to measure reflectance in the test structure having interdigitated implanted/unimplanted areas. The measurement over the test structure is then used in act 405 to look up the width/pitch ratio from the calibration data as illustrated above in reference to FIG. 2C. Also in act 405, the looked-up ratio is multiplied with the mask pitch to obtain the width of the implanted area.

Note that although implanted/unimplanted areas are described in the previous paragraph as being interdigitated in some embodiments, other embodiments are performed on interdigitated regions of two different concentrations of ions (obtained when the unimplanted regions of the previous paragraph are replaced by regions with a background concentration of ions that are either implanted or present in the substrate as grown).

Next, in act 406, the shadow width is calculated by subtracting the implant width from the opening width (which is determined as the difference between the mask pitch and the mask width). Thereafter, the tilt angle is calculated as the inverse tangent of the ratio of opening width and mask thickness. Note that FIG. 4 shows an arrow from act 402 into act 406 to indicate that the measured mask width and thickness are required for the calculation of the tilt-angle. Thereafter, the tilt angle as obtained in act 406 is checked against predetermined limits in act 407, and if acceptable then the wafer 105 is annealed as per act 408 (i.e. transferred to annealer 101A in FIG. 1A for further processing).

Note that in some embodiments, the acts 402 and 404-407 are performed repetitively for each of several dies (typically 13 dies at the center and 4 dies each at ⅓ radius, ⅔ radius, and edge, along each of several radii (e.g. four radii going North, South, East, West from wafer center). Measurement of Wmask, Tmask and Pmask in act 402 in each die wherein a reflectance measurement is to be performed in act 404 eliminates issues of global nonuniformity which otherwise introduce errors. In such embodiments, if the tilt angle for even one die falls outside predetermined limits, then the tilt angle of the ion implanter may be adjusted.

In some embodiments, the measurements described herein in reference to FIG. 4 are not performed in every wafer but only performed occasionally, e.g. in a diagnostic wafer to ensure proper maintenance of the ion implanter. In other embodiments, such measurements are performed in every production wafer (or every other production wafer, or every “N” production wafers where N is a preset constant). In such other embodiments, if the tilt angle is found to require adjustment (as noted in the previous paragraph), then the production wafer itself is deemed to be unacceptable and discarded as per act 409. Alternatively, the production wafer may be further processed if the tilt angle as measured falls outside the limits but only for dies that are fewer in number than a predetermined limit (e.g. less than 2% of the dies).

As noted above, when a production wafer is deemed unacceptable and discarded, the ion implanter 101I (FIG. 1A) is adjusted. Such adjustment may be made by a control signal on a bus 107 which indicates the difference between the measured tilt angle and a nominal tilt angle (which is shown on the ion implanter as the angle currently in use, prior to adjustment). Alternatively, the control signal on bus 107 may indicate a measured tilt angle to which ion implanter 101I is responsive. After tilt angle adjustment, another wafer is implanted by returning to act 403. Note that after act 408 as well, another wafer is implanted, but with the ion implanter kept unadjusted.

In some embodiments, a set of reference wafers having the same test patterns with the same dimensions of Wmask, Pmask, and Tmask are implanted at varying pre-determined tilt-angles and then measured as per act 202A to create a calibration curve as shown in FIG. 6. Such calibration curve must be prepared for each of several different implant species, energy, and dose that are likely to be used in production wafers e.g. Boron 10 keV, 3e12/cm² dose. The signal in FIG. 6 increases towards a maximum value corresponding to a signal from a fully unimplanted region (point 231 in FIG. 2C), since Wimplant decreases toward zero with increasing tilt-angle. A measurement of the signal for a production wafer implanted at an unknown tilt-angle is made by act 202A, and the measured signal value is used to look up a corresponding tilt angle from the calibration curve (as shown by arrows 601 and 602 in FIG. 6, a signal measurement of 10K microvolts identifies the tilt angle to be 26.6 degrees in this example). Note that instead of preparing and looking up a curve, a lookup table may be created and used to identify tilt angle by use of such calibration data.

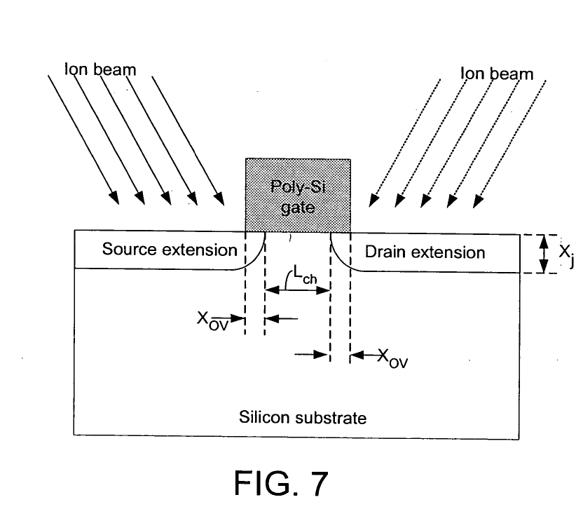

In some embodiments, a method of the type illustrated in FIG. 4 is used to fabricate sub-100 nm CMOS devices of the type illustrated in FIG. 7. Specifically, such devices have shallower source/drain extension (SDE) region than in the prior art, in order to maintain high performance. To that extent, it is beneficial to employ diffusion-less anneal techniques such as laser annealing to minimize the final SDE junction depth (Xj). However, this diffusion-less approach also eliminates the SDE overlap (Xov) under the poly-Si gate, an important device parameter that also controls performance.

For this reason, some embodiments use a high tilt-angle for the source/drain extension to place the implant ions (also called “dopants”) under the gate prior to anneal to produce the desired amount of Xov. The precise control of the SDE gate overlap becomes increasingly critical for shorter channel length (Lch) devices, since Xov becomes a significant fraction of the transistor channel length. The same amount of error in Xov has a much greater impact on the transistor performance for shorter channel devices. For this reason, the tilt angle is precisely controlled in such embodiments by a feedback loop that is implemented by bus 107 (FIG. 1A).

In the embodiment illustrated in FIG. 7, note that ion implantation is performed in two directions, by rotating the wafer during ion implantation. In such an embodiment, depending on the implant energy and gate thickness, the tilt angle changes the signal in a direction that is reverse of the direction 234 in FIG. 2C. Specifically, as the tilt angle is increased, the relation moves along the line 230 from point 233 towards point 232. This happens because with increasing tilt angle, more and more of the region under the gate is implanted with ions. On the other hand, when there is no rotation of the wafer, the increase in tilt angle causes the relation to move from point 233 towards point 231.

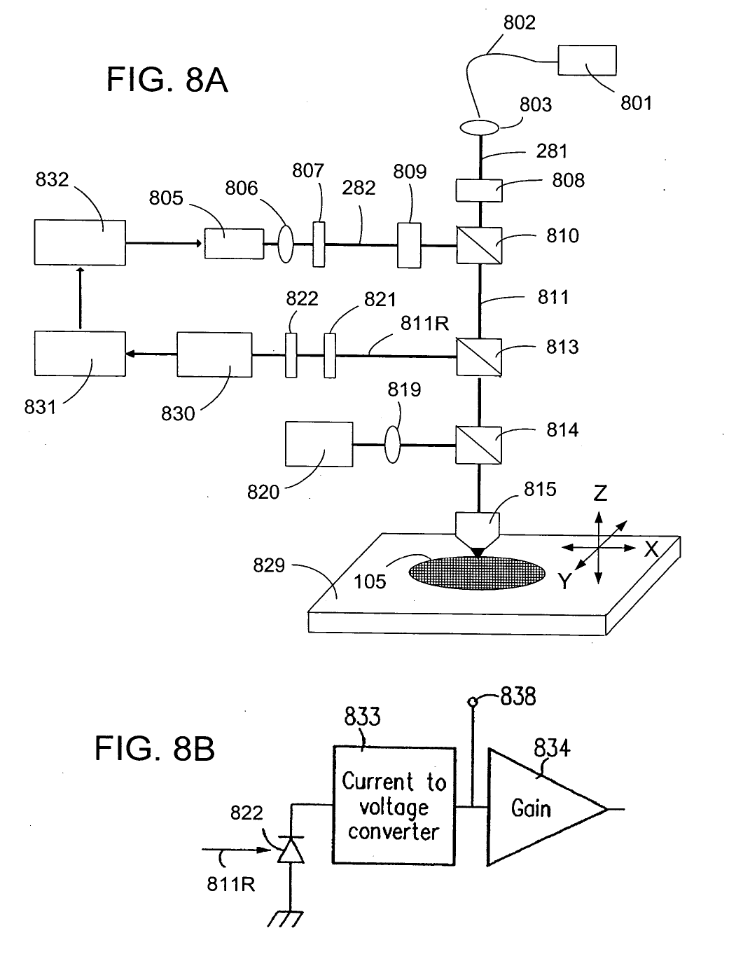

In one example, probe beam 281 is generated by a laser 801 (FIG. 8A), such as a 980 nm fiber coupled laser diode, model 26-8052-150 having a maximum output power of 150 milliwatts, available from JDS Uniphase, San Jose, Calif. Fiber 802 carries the output of laser 801 to a collimating lens 803, which produces a collimated beam 281.

In this implementation, pump beam 282 is created by an above bandgap laser 805, such as 830 nm laser diode model SDL-5432-H1 having a maximum output power of 200 milliwatts, available from JDS Uniphase, San Jose, Calif. Lens 806 collimates, and anamorphic prism 807 circularizes the pump beam 282.

The relation between wavelengths of beams 281 and 282 produced by lasers 801 and 805 is a critical aspect in one embodiment and leads to unexpected results, for example when beam 282 contains photons having energy above silicon's bandgap energy and beam 281 contains photons having energy approximately the same as or less than the bandgap energy. In this example, for a silicon wafer the 830 nm and 980 nm wavelength beams provide one or more benefits described herein (e.g. generate a negligible percentage of measurement-related carriers).

Note that depending on the embodiment, probe beam 281 may be polarized along the length of diffused areas 215A-215N (i.e. polarized along a line perpendicular to the plane of the paper in FIG. 2B), although the probe beam 281 may also be unpolarized depending on the embodiment. Polarization of either or both of the pump and probe beams 282 and 281 parallel to the length increases sensitivity to the presence of the doped areas 215A-215N and undoped areas 216A-216N−1 between those areas, as described in the U.S. patent application Ser. No. 09/521,232 filed Mar. 8, 2000, Attorney Docket No. BOX008 US now issued as U.S. Pat. No. 6,812,047 that is incorporated by reference herein in its entirety. Note that various reflection components arise when the probe beam 281 is incident on semiconductor wafer 105 (FIG. 2B) in a manner similar to that described in U.S. patent application Ser. Nos. 10/253,119 and 10/253,121 in reference to FIG. 7A therein.

Hence, in some embodiments, beam 281 and/or beam 282 is a linearly polarized beam whose direction of polarization is oriented parallel to a longitudinal direction of the bars in the interdigitated test structure. For more information on polarization of either or both of the pump and probe beams 281 and 282 parallel to the length of interdigitation to increase sensitivity to the presence of the doped regions and spaces between those regions, see the U.S. patent application Ser. No. 09/521,232 incorporated by reference above.

Tilt angle identifier 103 of some embodiments also includes optical isolators 808 and 809 that prevent back reflections from entering lasers 801 and 805, respectively. Moreover, tilt angle identifier 103 also includes partially transmissive mirror 810, such as a dichroic mirror, e.g. part number SWP45-Rp1047-Tp830 available from CVI Laser of Albuquerque, N. Mex., that combines beams 281 and 282, thereby to create a combined and collinear beam 811.

Beam 811 passes through 50:50 beam splitter 813, and 90:10 beam splitter 814 to objective lens 815. Objective lens 815 can be, for example, 100×, 0.8 NA lens part number LMPL100XIR available from Olympus of Tokyo Japan. Lens 815 focuses the combined beam 811 onto the surface of wafer 105.

Tilt angle identifier 103 also includes stage 829 that is used to move wafer 105 relative to beam 811 in the X, Y and Z directions. Specifically, stage 829 can be moved in the vertical direction along the Z axis to adjust focus, and in a horizontal plane to adjust the position of region 296 of FIG. 3A relative to beam 811 (also required by step 202A in FIG. 2A).

Beam 811, after reflection by wafer 105, is re-collimated by lens 815. Beam splitter 814 diverts 10% of the return beam to lens 819 and camera 820, which provide a system to align the beam spot to regions in the test structure of interest. Not shown is an auto-focus system that consists of a pinhole and a detector, which also uses the portion of the return beam diverted by beam splitter 814. The remaining portion of the return beam then enters beam splitter 813, which deflects a portion of it as beam 811R to optical filter 821. Filter 821 passes the light from probe laser 801 into detector 822, but blocks light from pump laser 805 (i.e. any reflected portion of the pump beam) from reaching detector 822.

Detector 822 is a silicon photodiode. The photodiode currents are converted to voltages and amplified electronically using signal processing circuit 830, the output of which goes to lock-in amplifier 831. The output of lock-in 831 goes to a digital computer, which receives the signal and presents it to the user or other data collection systems. Lock-in 831 also includes a frequency reference that is used to modulate laser driver 832 (such as model 8000 from Newport Corp. of Irvine Calif.), which provides a modulated drive output for generation laser 805. The modulation frequency is set to a value in the range of 1 Hz to 20,000 Hz to avoid the creation of a wave of carriers in wafer 105.

Detector 822 converts the instantaneous power of beam 811R into a current that is supplied to current-to-voltage converter 833 that is part of signal processing circuit 830 (FIG. 8B). Converter 833 can be, for example, a single stage op-amp transimpedance amplifier using an OP-27A integrated circuit from Analog Devices.

Converter 833 converts the current from photo cell 822 into a voltage that is provided to a single gain stage 834 also included in circuit 830. Gain stage 834 provides an additional signal gain over the gain provided by converter 833, because converter 833 is limited to a few kilohms. The gain in converter 833 is limited because converter 833 is dc coupled, and the power of reflected beam 811R is a few milliwatts, so that excess transimpedance gain will cause converter 833 to saturate.

Converter 833 is ac coupled to amplifier 834. In one embodiment, a constant component of the reflectance (as opposed to the reflectance component at the modulation frequency) is measured from the signal at a node 838 that is located between converter 833 and amplifier 834. Tilt angle identifier 103 uses the constant component to normalize the intensity measurement, and compares the normalized measurement between wafers (e.g. between a wafer under fabrication and a reference wafer). The voltage signal provided by amplifier 834 is coupled to lock-in amplifier 831, such as model 7265 available from Perkins Elmer Corp., Wellesley, Mass.

Numerous modifications and adaptations of the embodiments described herein will become apparent to the skilled artisan in view of this disclosure.

In many embodiments, a test structure includes interdigitated implanted/unimplanted areas as well as an area that is fully masked and another area that is fully open, and the test structure is present in every die of the wafer although the tilt angle is measured only in dies at certain predetermined locations in the wafer. Although some of embodiments described herein have unimplanted areas, alternative embodiments of the invention have areas that have been previously implanted with a background concentration of the same specie ions as described elsewhere herein.

In many embodiments described herein, sub-wavelength features are evaluated. Typically, there are multiple implanted areas—say 5—under the laser beam spot. For example, both the implanted and unimplanted areas might be 0.2 μm wide, and the spot is about 2 μm in diameter, so there would be 5 implanted areas under the spot for this example. The number of implanted and unimplanted line pairs in the test structure may be large, say 100, which means the entire width of the pattern is much larger than the spot. In the example above of 0.2 μm wide implanted and unimplanted lines, 100 line pairs produce a 40 μm wide test pattern, which is much larger than the 2 μm spot. With multiple number of line pairs under the spot and a total pattern width larger than the spot size, small errors in registration of the spot to the test pattern will have a negligible effect on the signal. In this case, the measurement can be made rapidly. In an embodiment where the total pattern width is comparable to the spot size, the spot must be carefully registered to the test pattern.

Moreover, instead of reflectance measurement as per act 202A (FIG. 2A), other embodiments may measure other properties affected by implanted ions, such as the refractive index. To cover both kinds of measurements (reflectance measurement and refractive index measurement) act 112 (FIG. 1B) described above does not specify reflectance measurement.

Also, in an interdigitated structure of the type described above, each bar 123I (FIG. 1C) and each opening 124I can have any size relative to the width Wpattern (FIG. 3A) of the patterned region (formed by interdigitated implanted and unimplanted areas). In some embodiments, several patterns are formed, e.g. one pattern in each of a number of dies that are spaced uniformly across a wafer (e.g. 10 dies in a wafer of 100 dies).

In another embodiment, several sets of bars with a range of opening widths are provided, e.g. each bar pattern has a common bar width Wmask of 0.20 μm, but a different one of opening widths Wopen: 0.12 μm, 0.15 μm, 0.18 μm, 0.22 μm, 0.25 μm, and 0.30 μm, and each bar pattern occupies 25×25 μm area. In other embodiments, the sets of bars may have a common spacing width but a different one of bar widths. In still other embodiments, both kinds of bar sets are used.

Furthermore, although a specific order of performance of acts has been illustrated in the drawings and described in the text for certain illustrative embodiments, it is to be understood that the order can be changed in other embodiments. For example, although act 202B is illustrated as being performed after act 202A, these two acts can be performed in the reverse order. Moreover, although acts 202A and 202B are shown as being performed after act 201, in some embodiments the calibration act 202B is performed prior to act 201 by use of a separate calibration wafer (which is implanted at a tilt angle of 0°).

Note that the calibration data of the type illustrated in FIGS. 2C, 5 and 6 is independent of implant tilt-angle, in the sense that the signal is equally sensitive regardless of the tilt angle. Hence methods of the type described herein differ from measurement of tilt angle by use of THERMAWAVE's tool described in the background section above. Specifically, THERMAWAVE's tool appears to measure a signal that arises from a channeling effect which in turn depends on process conditions (such as the tilt angle at which ions are implanted). To the inventors' knowledge there appears to be no prior art description of determining width of shadow of bar in the manner described herein. Moreover, there appears to be no prior art description of using the shadow width with the mask thickness to compute the tilt angle.

Numerous modifications and adaptations of the embodiments described herein are encompassed by the scope of the invention.

1. A method for evaluating a semiconductor wafer comprising a test structure implanted with ions, the method comprising:
making a first measurement of light reflected from an area in the wafer that is lacking said ions;
making a second measurement of light reflected from a test structure;
wherein the test structure comprises a plurality of first areas interdigitated with a plurality of second areas, the first areas comprising said ions implanted at a tilt angle relative to a surface of the semiconductor wafer and the second areas lacking said ions;
wherein the reflected light that is measured in the second measurement comprises reflections from the first areas and reflections from the second areas; and
determining the tilt angle by use of at least (A) the first measurement and the second measurement, (B) pitch of the test structure, and (C) thickness of a layer protective of the second areas during ion implantation.

2. The method of claim 1 wherein the determining comprises:
using the first and second measurements, and at least the pitch, to determine a first width of the first areas.

3. The method of claim 2 further comprising:
measuring a second width of openings In the layer protective of the second areas during ion implantation;
using the first width and the second width to compute a third width of a region that is located in shadow during implantation of said ions.

4. The method of claim 3 further comprising:
measuring the thickness of the layer that protects the second areas during implantation of said ions;
computing a ratio of the third width and the thickness; and
finding an inverse tangent of the ratio, to determine the tilt angle.

5. The method of claim 3 wherein:
the second width is measured by use of a scanning electron microscope (SEM).

6. The method of claim 1 further comprising:
using a set of reference wafers to create calibration data; and
using said calibration data created from said reference wafers and the second measurement to determine the tilt angle.

7. The method of claim 1 further comprising:
using the tilt angle obtained from the determining in implanting another wafer with said ions.

8. The method of claim 1 further comprising:
using the tilt angle obtained from the determining in deciding whether the semiconductor wafer is to be processed further.

9. The method of claim 1 wherein each of the making of first measurement and the making of second measurement comprises:
illuminating at least a portion of the test structure with a first beam to generate a plurality of charge carriers;
illuminating with a second beam at least some of the charge carriers in the plurality generated by the first beam; and
measuring light of the second beam reflected by the at least some of the charge carriers.

10. The method of claim 9 further comprising:
modulating intensity of the first beam at a predetermined frequency; and
using the predetermined frequency during the measuring.

11. The method of claim 10 wherein:
the predetermined frequency is sufficiently low to avoid creation of a wave of the charge carriers in space.

12. The method of claim 10 wherein:
the predetermined frequency is sufficiently high to create a wave of the charge carriers in space.

13. The method of claim 9 further comprising:
making a third measurement of light reflected from an area in the wafer that is at least partially doped by said ions at a known angle; and
using at least each of the measurements, Including the third measurement, to determine the tilt angle.

14. The method of claim 9 further comprising:
making a third measurement of light reflected from an area in the wafer that is implanted at 100% dose by said ions at a known angle; and
using each of the measurements, including the third measurement, in determining the tilt angle.

15. The method of claim 14 wherein:
the known angle is zero degrees.

16. The method of claim 9 wherein:
at least one of the first beam and the second beam is polarized.

17. The method of claim 16 wherein:
each of the first beam and the second beam is polarized.

18. The method of claim 16 wherein:
polarization is parallel to each of the first regions and each of the second regions.

19. The method of claim 9 wherein:
each of the first beam and the second beam are coincident.

20. The method of claim 9 wherein:
the second beam has a wavelength greater than the pitch.

21. The method of claim 9 wherein:
the second beam has a diameter greater than the pitch.

22. The method of claim 9 wherein:
the diameters of the first beam and the second beam are both greater than the pitch; and
the second beam has a wavelength that is also greater than the pitch.

23. The method of claim 1 wherein the determining comprises:
using at least one of the first and second measurements, and at least the pitch, to determine a first width of the first areas.

24. A method for evaluating a semiconductor wafer comprising a test structure implanted with ions, the method comprising:
making an a first measurement of light reflected from an area in the wafer that has a background concentration of said ions;
making a second measurement of light reflected from a test structure;
wherein the test structure comprises a plurality of first areas interdigitated with a plurality of second areas, the first areas comprising said ions implanted at a tilt angle relative to a surface of the semiconductor wafer at concentration higher than said background concentration and the second areas comprising said ions at said background concentration;
wherein the reflected light that Is measured in the second measurement comprises reflections from the first areas and reflections from the second areas; and
determining the tilt angle by use of at least (A) the first measurement and the second measurement, (B) pitch of the test structure, and (C) thickness of a layer protective of the second areas during ion implantation.

25. The method of claim 24 wherein the determining comprises:
using the first and second measurements, and at least the pitch, to determine a first width of the first areas.

26. The method of claim 25 further comprising:
measuring a second width of openings In the layer protective of the second areas during ion implantation;
using the first width and the second width to compute a third width of a region that is located in shadow during implantation of said ions.

27. The method of claim 26 further comprising:
measuring the thickness of the layer that protects the second areas during implantation of said ions;
computing a ratio of the third width and the thickness; and
finding an inverse tangent of the ratio, to determine the tilt angle.

28. The method of claim 26 wherein:
the second width is measured by use of a scanning electron microscope (SEM).

29. The method of claim 24 further comprising:
using a set of reference wafers to create calibration data; and
using said calibration data created from said reference wafers and the second measurement to determine the tilt angle.

30. The method of claim 24 further comprising:
using the tilt angle obtained from the determining in implanting another wafer with said ions.

31. The method of claim 24 further comprising:
using the tilt angle obtained from the determining in deciding whether the semiconductor wafer is to be processed further.

32. The method of claim 24 wherein each of the making of first measurement and the making of second measurement comprises:
illuminating at least a portion of the test structure with a first beam to generate a plurality of charge carriers;
illuminating with a second beam at least some of the charge carriers in the plurality generated by the first beam; and
measuring light of the second beam reflected by the at least some of the charge carriers.

33. The method of claim 32 further comprising:
modulating intensity of the first beam at a predetermined frequency; and
using the predetermined frequency during the measuring.

34. The method of claim 33 wherein:
the predetermined frequency is sufficiently low to avoid creation of a wave of the charge carriers in space.

35. The method of claim 33 wherein:
the predetermined frequency is sufficiently high to create a wave of the charge carriers in space.

36. The method of claim 32 further comprising:
making a third measurement of light reflected from an area in the wafer that is at least partially doped by said ions at a known angle; and
using at least each of the measurements, including the third measurement, to determine the tilt angle.

37. The method of claim 32 further comprising:
making a third measurement of light reflected from an area in the wafer that is implanted at 100% dose by said ions at a known angle; and
using each of the measurements, including the third measurement, in determining the tilt angle.

38. The method of claim 37 wherein:
the known angle is zero degrees.

39. The method of claim 32 wherein:
at least one of the first beam and the second beam is polarized.

40. The method of claim 39 wherein:
each of the first beam and the second beam is polarized.

41. The method of claim 39 wherein:
polarization is parallel to each of the first regions and each of the second regions.

42. The method of claim 32 wherein:
each of the first beam and the second beam are coincident.

43. The method of claim 32 wherein:
the second beam has a wavelength greater than the pitch.

44. The method of claim 32 wherein:
the second beam has a diameter greater than the pitch.

45. The method of claim 32 wherein:
the diameters of the first beam and the second beam are both greater than the pitch; and
the second beam has a wavelength that is also greater than the pitch.

46. The method of claim 24 wherein the determining comprises:
using at least one of the first and second measurements, and at least the pitch, to determine a first width of the first areas.

47. A method for evaluating a semiconductor wafer comprising a test structure implanted with ions, the method comprising:
making an a first measurement of light reflected from an area in the wafer that is lacking said ions;
making a second measurement of light reflected from a test structure;
wherein the test structure comprises a plurality of first areas interdigitated with a plurality of second areas, the first areas comprising said ions implanted at a tilt angle relative to a surface of the semiconductor wafer and the second areas lacking said ions;
wherein the reflected light that is measured in the second measurement comprises reflections from the first areas and reflections from the second areas; and
using the first measurement, the second measurement, a third measurement and the pitch, to determine a first width of the first areas.

48. The method of claim 47 further comprising:
measuring a second width of openings in the layer protective of the second areas during ion implantation;
determining the tilt angle by use of (A) the first width (B) the second width and (C) thickness of said layer.

49. A method for evaluating a semiconductor wafer comprising a test structure implanted with ions, the method comprising:
making an a first measurement of light reflected from an area in the wafer that has a background concentration of said ions;
making a second measurement of light reflected from a test structure;
wherein the test structure comprises a plurality of first areas interdigitated with a plurality of second areas, the first areas comprising said ions implanted at a tilt angle relative to a surface of the semiconductor wafer, said first areas comprising said ions in a concentration greater than the background concentration, and the second areas comprising said background concentration of said ions;
wherein the reflected light that is measured in the second measurement comprises reflections from the first areas and reflections from the second areas; and
using the first measurement, the second measurement, a third measurement and the pitch, to determine a first width of the first areas.

50. The method of claim 47 further comprising:
measuring a second width of openings in the layer protective of the second areas during ion implantation;
determining the tilt angle by use of (A) the first width (B) the second width and (C) thickness of said layer.

51-54. (canceled)

55. A method for evaluating a semiconductor wafer comprising a test structure implanted with ions, the method comprising:
making a first measurement of light reflected from an area in the wafer;
making a second measurement of light reflected from a test structure;
wherein the test structure comprises a plurality of first areas interdigitated with a plurality of second areas, the first areas comprising said Ions implanted at a tilt angle relative to a surface of the semiconductor wafer;
wherein the reflected light that is measured in the second measurement comprises reflections from the first areas and reflections from the second areas; and
determining the tilt angle by use of at least (A) the first measurement and the second measurement, (B) pitch of the test structure, and (C) thickness of a layer protective of the second areas during ion Implantation.

56. A method for evaluating a semiconductor wafer comprising a test structure implanted with ions, the method comprising:
making a first measurement of light reflected from an area in the wafer;
making a second measurement of light reflected from a test structure;
wherein the test structure comprises a plurality of first areas interdigitated with a plurality of second areas, the first areas comprising said ions implanted at a tilt angle relative to a surface of the semiconductor wafer;
wherein the reflected light that is measured In the second measurement comprises reflections from the first areas and reflections from the second areas; and
determining a geometric property of the first areas by use of at least (A) the first measurement and the second measurement, (B) pitch of the test structure, and (C) thickness of a layer protective of the second areas during ion implantation.
